(19) United States
(12) Patent Application Publication
(10) Pub. No.: US 2007/0168887 A1
(43) Pub. Date: Jul. 19, 2007

(54) Apparatus and method for providing user interface for file search

(75) Inventor: Hyung-Jong Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/606,952

(22) Filed: Dec. 1, 2006

(30) Foreign Application Priority Data
Jan. 10, 2006 (KR) 2006-2864

(51) Int. Cl. G06F 3/048; G06F 17/30

(52) U.S. Cl. 715/855; 707/3

(57) ABSTRACT

An apparatus and method for providing a user interface for file search are provided to achieve easier and more convenient search, storage and management of files. The apparatus includes a user interface providing a graphic user interface by which a user searches for a file; an additional information storage unit storing additional information in relation to a predetermined file, which is input through the graphic user interface by the user; and a control unit for displaying the additional information on the graphic user interface.

### CROSS-REFERENCE TO RELATED APPLICATIONS

This application claims all benefits accruing under 35 U.S.C. §119 from Korean Patent Application No. 2006-2864, filed on Jan. 10, 2006 in the Korean Intellectual Property Office, the disclosure of which is incorporated herein by reference.

### BACKGROUND OF THE INVENTION

1. Field of the Invention

The present invention relates to an apparatus and method for providing a user interface for file search, and more particularly, to an apparatus and method for providing a user interface, which can achieve easier and more convenient search, storage and management of files.

2. Related Art

Graphic user interfaces (GUIs) are program interfaces that allow a user to take advantage of a computer's graphics capabilities to make a program easier to use. GUIs have been developed to reduce the inconvenience of typical user interfaces which require a user to input data using an input device, such as a keyboard, and to memorize a considerable number of complex commands.

Most of the existing operating systems support GUIs, and many application programs use specific GUI elements with different features to display information or allow the user to interact with the program. Examples of operating systems (OS) that support GUIs are Apple Mac OS, Microsoft Windows (Windows 95, Windows XP or Windows 2000), NEXTSTEP and the X Window system installed in an electronic device such as a host computer. Examples of basic GUI elements include windows, menus, buttons, check boxes, pointers, icons and other gadgets used to carry out commands such as open files, delete files, move files, etc., without learning complex command languages. For example, a pointer is a symbol that appears on a display screen and that can be moved by a user, via a pointing device such as a mouse or trackball, to select objects and commands on the display screen. An icon is a small picture that represents commands, files or windows and that can be moved by the user, via a pointing device, around the display screen. If the pointer is moved to the icon and a mouse button is pressed, a command can be executed or the icon can be converted into a window.

Generally, in order to search, store and manage a file, the graphic user interface (GUI) provides a user with information including a filename, a file size, a file type, and an update date of a predetermined file, so that the user can easily access and process the file. Therefore, the user can use the graphic user interface (GUI) provided by the operating system (OS), in order to search for a desired file and perform various tasks with the searched file. However, in the event where the user cannot remember the filename, or there are multiple existing filenames that are similar to the filename of the searched file, the user must perform an additional task of identifying each of multiple files, in order to find the file in question. Further, when the graphic user interface (GUI) includes directories as well as predetermined files, the user may search and open a corresponding directory and then check each of multiple files in the directory, in order to find the file which the user wants to process. In addition, the user may provide priorities to files in processing the files. Specifically, the user may change the filename or the icon of a file in order to indicate which file should be processed in the first place. As a result, when the user recognizes the graphic user interface (GUI) later, the user can notice from the filename or icon that the file should be processed in the first place.

Unfortunately, the changed filename or changed icon in the graphic user interface (GUI) typically has a low readability or intuitiveness. As a result, it is not easy for the user to find the file, which should be first processed, later in the graphic user interface (GUI). For example, the user graphic interface may display an icon at one side of the filename of a predetermined file, which indicates the type of the file. However, the icon displayed at one side of the filename is relatively small, so that it is not easy for the user to identify the icon at a glance. Therefore, there have been many requests for a solution which can improve the readability or intuitiveness of a file, which should be first processed, so that the user can easily find the file through the graphic user interface (GUI).

One solution is disclosed in Korean Laid-Open Patent No. 2005-0047488 which relates to a method of speed browsing media items of a media diary application for personal schedule information, in which a specific media icon is given to each schedule item. The disclosed method relates to provision of browsing speed or scrolling function which may be different according to user's desire. However, there has not been any proposed solution for improving the readability of a file by providing a priority to the file in searching for the file.

### SUMMARY OF THE INVENTION

Several aspects and example embodiments of the present invention provide an apparatus and method for providing a user interface for file search, in which additional information in relation to a predetermined file input by a user is displayed on a graphic user interface (GUI), so that the user can easily find the file in order to process the file.

Additional aspects and/or advantages of the invention will be set forth in part in the description which follows and, in part, will be obvious from the description, or may be learned by practice of the invention.

In accordance with an example embodiment of the present invention, there is provided an apparatus for providing a user interface, the apparatus including a user interface unit arranged to provide a graphic user interface (GUI) by which a user searches for a file; an additional information storage unit to store additional information in relation to a predetermined file input, via the graphic user interface (GUI) by the user; and a control unit arranged to provide a visual display of the additional information on the graphic user interface (GUI).

According to an aspect of the present invention, the graphic user interface (GUI) may comprise at least one filename of a file, and the additional information comprises at least one of a memo, a number, a leader line, a rim, and a font of the filename, wherein the memo, the number, the leader line, and the rim are additionally displayed on the graphic user interface (GUI) at one side of the filename.

According to an aspect of the present invention, the apparatus further comprises a user input unit to enable the user to input user information; and a link information storage unit to store link information between the additional information stored in the additional information storage unit and the predetermined file corresponding to the stored additional information.

According to a further aspect of the present invention, the user input unit comprises at least one button, and a selection menu is displayed on the graphic user interface (GUI) when the user operates a predetermined button, and wherein the selection menu comprises menu items corresponding to additional information which can be input.

According to a further aspect of the present invention, the control unit arranges filenames on the graphic user interface (GUI) based on the additional information. In accordance with another example embodiment of the present invention, there is provided a method of providing a user interface. Such a method comprises providing a graphic user interface (GUI) by which a user searches for a file; storing additional information in relation to a predetermined file, which is input through the graphic user interface (GUI) by the user; and displaying the additional information on the graphic user interface (GUI).

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of an apparatus for providing a user interface for file search according to an example embodiment of the present invention;

FIG. 2 illustrates a graphic user interface according to an example embodiment of the present invention;

FIG. 3 illustrates a graphic user interface with rims around filenames according to another example embodiment of the present invention;

FIG. 4 illustrates a graphic user interface with memos in word balloons beside filenames according to another example embodiment of the present invention;

FIG. 5 illustrates a graphic user interface with filenames in a modified font according to another example embodiment of the present invention;

FIG. 6 illustrates a graphic user interface with encircled numbers added to filenames according to another example embodiment of the present invention;

FIG. 7 shows an example of the selection menu according to an example embodiment of the present invention; and

FIG. 8 is a flowchart of a method of providing a user interface for file search according to an example embodiment of the present invention.

### DETAILED DESCRIPTION OF THE EMBODIMENTS

The present invention is described with reference to block diagrams or flowcharts for illustrating apparatuses and methods for transmitting an event in a web-based system according to example embodiments of the present invention. It will be understood, however, that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

In addition, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Reference will now be made in detail to the present embodiments of the present invention, examples of which are illustrated in the accompanying drawings, wherein like reference numerals refer to the like elements throughout. The embodiments are described below in order to explain the present invention by referring to the figures.

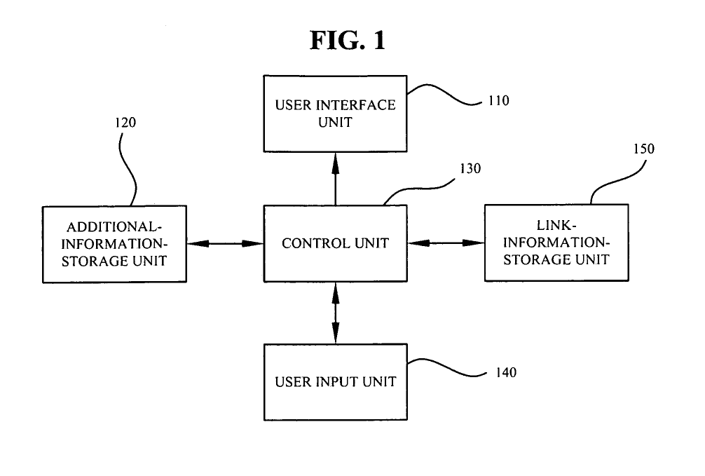

FIG. 1 is a block diagram of an apparatus for providing a user interface for file search according to an example embodiment of the present invention. Such an apparatus may be installed in an electronic device, such as a host computer (i.e., desktop or laptop) or a portable device (i.e., personal digital assistant “PDA” or cell phone).

As shown in FIG. 1, the apparatus 100 for providing a user interface includes a user interface unit 110, an additional information storage unit 120, a control unit 130, a user input unit 140, and a link information storage unit 150.

The user interface unit 110 provides a graphic user interface (GUI) which displays a filename, a file size, a file type, an update date, etc. of each file, so that the user can search for the file. In addition, in the graphic user interface (GUI), an icon based on the file type of each file is displayed at one side of the filename of the file, so as to increase the intuitiveness of the file type. Then, the user can search for a predetermined file through a graphic user interface (GUI) displayed on a display screen such as a computer monitor. The graphic user interface (GUI) may be a window searcher provided by the Windows XP professional, which is an operating system (OS) provided by Microsoft Corp.

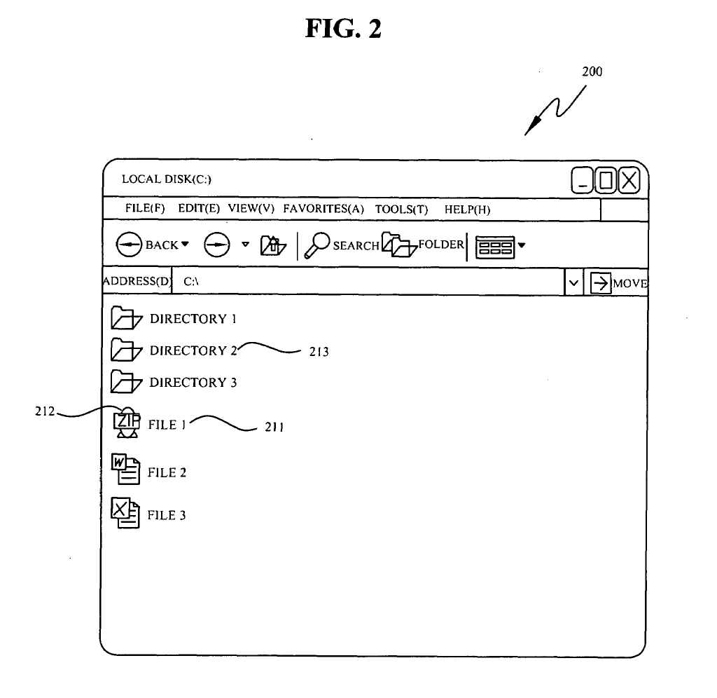

An example graphic user interface (GUI) according to an embodiment of the present invention is shown in FIG. 2. Specifically, the graphic user interface (GUI) 200 provided by the user interface unit 110 includes a filename 211 of a predetermined file, an icon 212 indicating the file type, and a directory name 213, as shown in FIG. 2. The user can search for, store, and manage the file, via the graphic user interface (GUI) 200. Although the graphic user interface (GUI) 200 shown in FIG. 2 displays the filename 211, the icon 212, and the directory name 213, it is only an example to help understanding of the present invention. Of course, the graphic user interface 200 may selectively display the file size, the file type, the update date, etc. according to the user's setup, without departing from the scope of the invention.

In the example embodiments as described herein, the term “file” may refer to either a “unit file” or a “directory” which is a space for storing multiple files, and can be understood as including both the unit file and the directory.

The additional information storage unit 120 stores additional information about a predetermined file, which is input through the user input unit 140 by the user. The additional information input through the user input unit 140 by the user may include information additionally displayed on the graphic user interface (GUI) 200, as shown in FIG. 2, such as memo, rim, icon, etc., which are displayed at one side of a predetermined filename on the graphic user interface (GUI) 200, and information for modification or decoration of the filename in the graphic user interface (GUI) 200, such as font, font color, etc. of the filename. However, the present invention is not limited to the examples of the additional information stored in the additional information storage unit 120.

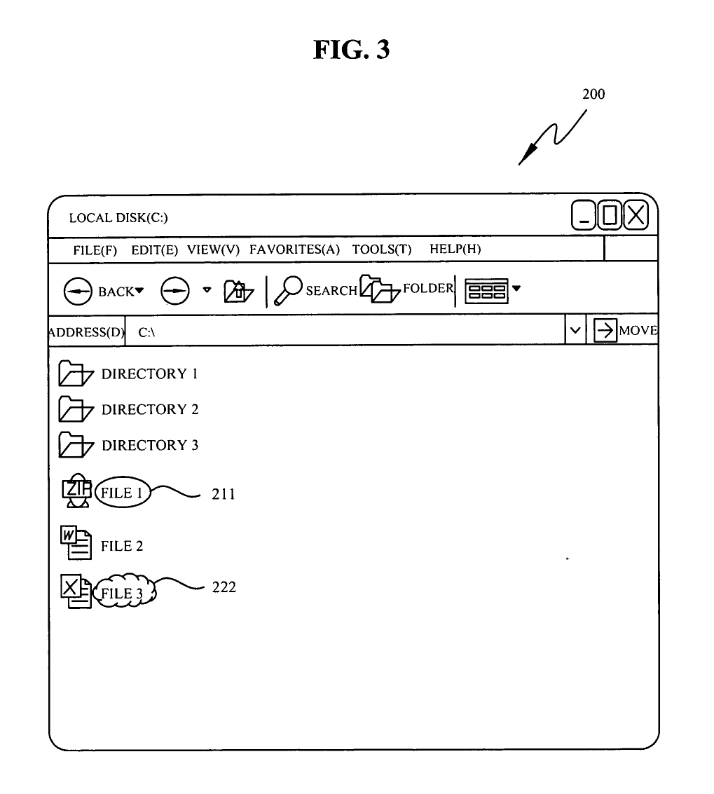

The control unit 130 displays the additional information stored in the additional information storage unit 120 on the graphic user interface (GUI) 200, as shown in FIG. 2. For example, a graphic user interface (GUI) 200 is provided with rims around filenames according to another example embodiment of the present invention is shown in FIG. 3. In particular, when the user inputs an ellipsoidal rim 221 or a cloud-like rim 222 to be marked around a filename of a predetermined file, via the user input unit 140, the input ellipsoidal rim 221 or cloud-like rim 222 is stored in the additional information storage unit 120, and the control unit 130 displays the ellipsoidal rim 221 or cloud-like rim 222 around the filename.

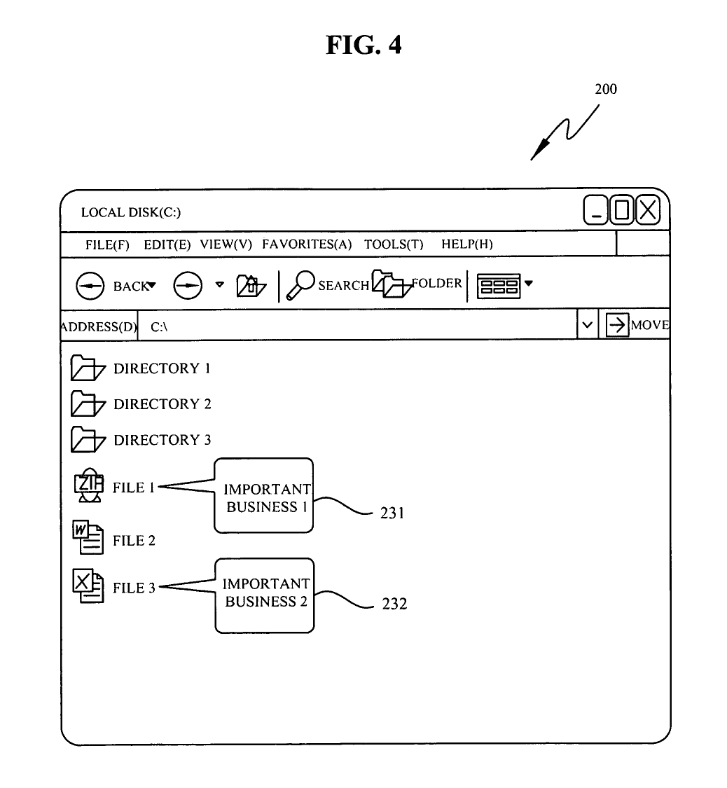

In addition, if the user inputs additional information to be displayed in the form of memo in a word balloon 231 or 232, via the user input unit 140, the memo in the word balloon 231 or 232 is stored in the additional information storage unit 120 and the control unit 130 displays the memo in the word balloon 231 or 232 beside the filename on the graphic user interface 200 provided by the user interface unit 110. For example, FIG. 4 illustrates a graphic user interface with memos in word balloons beside filenames according to another example embodiment of the present invention. Then, the user can easily find the filename to which corresponding additional information is attached, because the additional information is displayed beside of the corresponding file name.

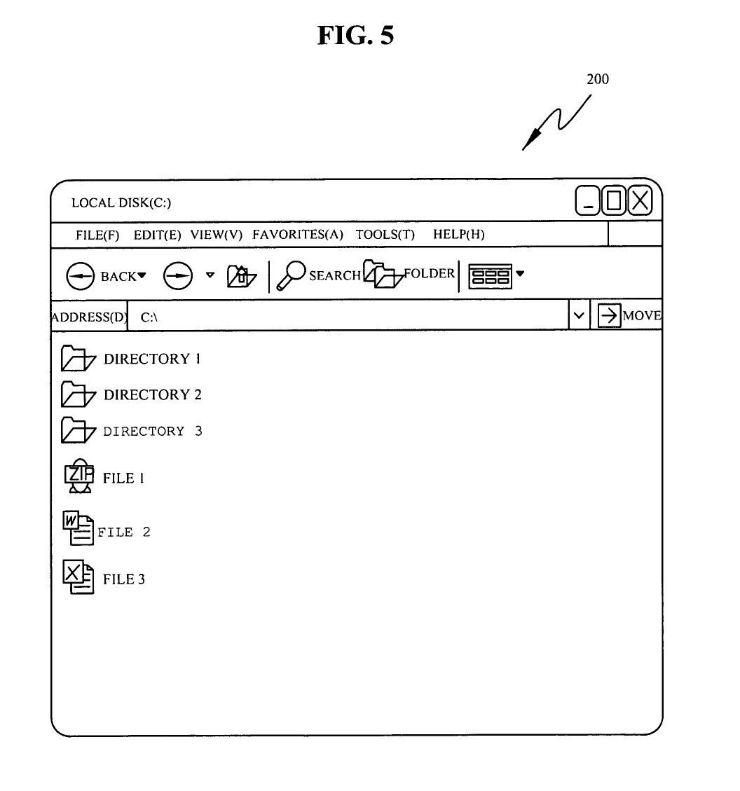

According to another example embodiment of the present invention, the control unit 130 can change the font of a filename as well as adding a rim or a memo, as shown in FIG. 3 and FIG. 4. For example, the control unit 130 may change the font of a directory named “directory 3” and a filename named “file 2” from “Times New Roman”, as shown in FIG. 2, to “Courier” as shown in FIG. 5. Of course, it is possible to change the color of the font, although not shown.

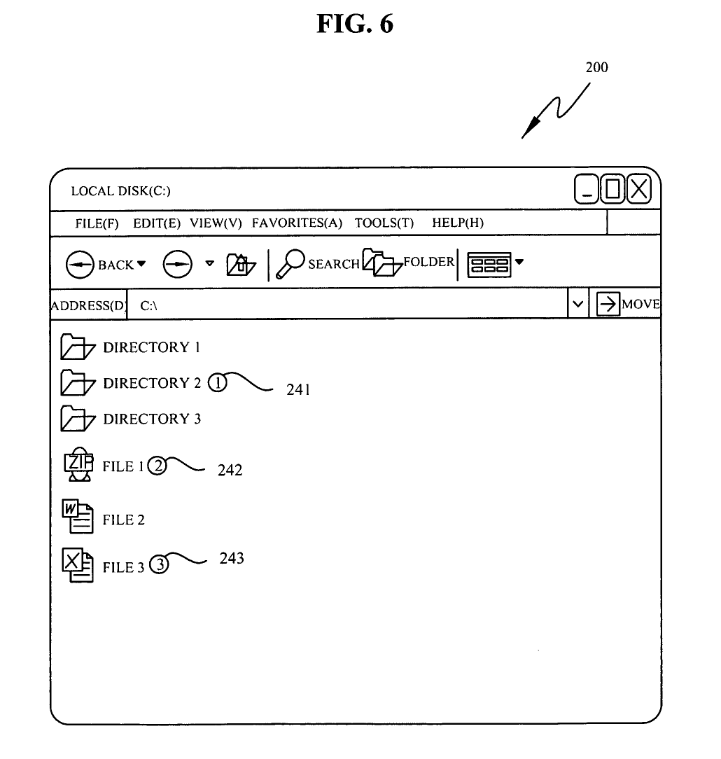

According to another example embodiment of the present invention, the control unit 130 can display encircled numbers \textcircled{1}, \textcircled{2}, and \textcircled{1} (designated by reference numerals 241, 242, and 243, respectively) of a predetermined sequence beside filenames, in order to show the sequence in which files with the filenames should be processed. The encircled numbers are input, via the user input unit 140, by the user and stored in the additional information storage unit 120. Although the encircled numbers in FIG. 6 are given to the filenames according to the sequence in which files with the filenames should be processed, the sequence of the numbers may be changed according to the purpose or necessity.

Through the user input unit 140, the user can input the additional information to be stored in the additional information storage unit 120. In accordance with the example embodiment of the present invention, the user input unit 140 is an input device including at least one button, such as a mouse or a keyboard. Further, the user input unit 140 may provide a selection menu from which the user can select additional information to input. In this case, the control unit 130 may display the selection menu on the graphic user interface (GUI) 200.

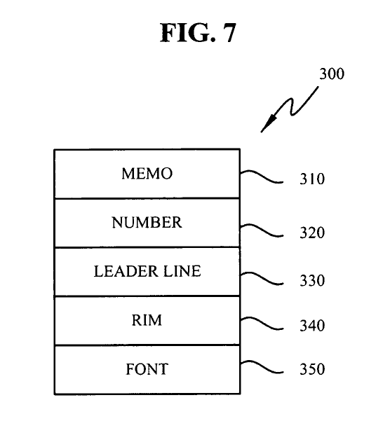

FIG. 7 shows an example of the selection menu 300 which may be displayed on the graphic user interface (GUI) 200, as shown in FIG. 2, when the user presses a predetermined button of the user input unit 140. As shown in FIG. 7, the selection menu 300 may include various items corresponding to the types of the additional information which the user can input, for example, memo 310 for input of memo, number 320 for input of numbers, leader line 330 for input of leader lines, rim 340 for input of rims having predetermined shapes, and font 350 for change of the font of filenames or directory names. However, the present invention is not limited to the enumerated menu items. Rather, the menu items can be added, deleted, or changed within the scope of the present invention.

Meanwhile, the user can use the user input unit 140, like a pen, as well as inputting the additional information of FIGS. 3 to 6. In other words, instead of inputting the predetermined additional information as shown in FIGS. 3 to 6, the user can input additional information in a different style according to the user's taste through the user input unit 140.

The link information storage unit 150 stores link information between a predetermined file and additional information in relation to the file input by the user. Therefore, even when the user closes and then opens again the graphic user interface in order to search for a file, the additional information stored in the additional information storage unit 120 can be displayed at one side of a corresponding file.

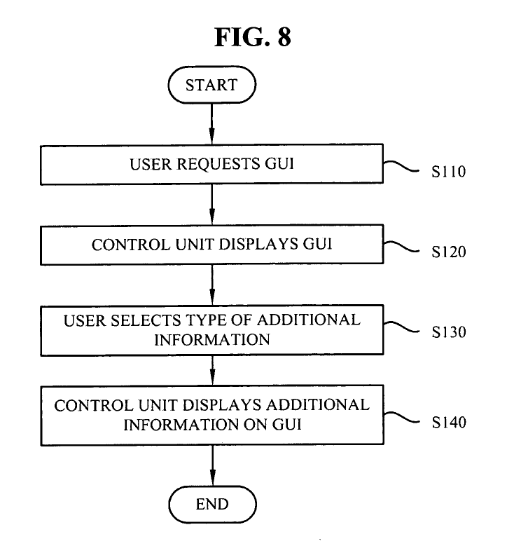

FIG. 8 is a flowchart of a method of providing a user interface for file search according to an example embodiment of the present invention. As shown in FIG. 8, the user first requests a graphic user interface (GUI) 200, as shown, for example, in FIG. 2, in order to search for a predetermined file at block S110.

Then, in response to the request from the user, the control unit 130, as shown in FIG. 1, displays the graphic user interface (GUI) 200, via the user interface unit 100, for file search at a display device at block S120.

Then, in order to input additional information for the predetermined file through the displayed graphic user interface (GUI) 200, the user selects the type of the additional information, via the user input unit 140 at block S130. Specifically, the user first requests a selection menu for selection of the type of the additional information through the user input unit 140, and then selects the type of the additional information from the selection menu displayed according to the user's request. The types of the additional information selectable by the user may include the same items as those in the selection menu, as shown, for example, in FIG. 7.

After selecting the type of the additional information to input, the user inputs contents of the selected additional information, for example, inputs contents of memo when the user has selected memo or selects a desired font when the user has selected the font. The control unit 130 displays the additional information input by the user on the graphic user interface (GUI) at S140.

The additional information input by the user is stored in the additional information storage unit 120, and the link information between the input additional information and a file corresponding to the input additional information is stored in the link information storage unit 150. Therefore, when the user searches for the file later through the graphic user interface (GUI) 200, the control unit 130 extracts the additional information from the additional information storage unit 120 by using the link information stored in the link information storage unit 150 and displays the extracted additional information on the graphic user interface (GUI) 200.

Further, after the additional information is input, the control unit 130 may display the additional information, while either maintaining the sequence of the filenames as they were before the input of the additional information, or discriminating between filenames for which the additional information has been input and filenames for which the additional information has not been input.

As used herein, the “unit” or “module” refers to a software element or a hardware element, such as a Field Programmable Gate Array (FPGA) or an Application Specific Integrated Circuit (ASIC), which performs a predetermined function. However, the unit or module does not always have a meaning limited to software or hardware. The module may be constructed either to be stored in an addressable storage medium or to execute one or more processors. Therefore, the module includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the modules may be either combined into a smaller number of elements or modules or divided into a larger number of elements or modules.

Various aspects and embodiments of the present invention can be written as computer programs and can be implemented in general-use digital computers that execute the programs using a computer readable recording medium. Examples of the computer readable recording medium include magnetic storage media (e.g., ROM, RAM, floppy disks, hard disks, etc.), optical recording media (e.g., CD-ROMs, DVDs, etc.), and storage media such as carrier waves (e.g., transmission through the Internet). The computer readable recording medium can also be distributed over network coupled computer systems so that the computer readable code is stored and executed in a distributed fashion. And the functional programs, codes and code segments for embodying the present invention may be easily deducted by programmers in the art which the present invention belongs to. In addition, both the apparatus and method for providing user interface for file search, as shown in FIG. 1 and FIG. 8, can be implemented as a library, or an application framework providing GUI elements. The apparatus, as shown in FIG. 1, can be a software module written in different computer programming languages, including, but not limited to C, C++, C#, Java and Delphi, and can be integrated in either the operating system (OS) or the GUI, or alternatively, resides as a separate layer on top of the operating system (OS) or the GUI. As described in the foregoing, the apparatus and method for providing a user interface for file search according to example embodiments of the present invention advantageously show the process priority of each file by displaying various types of additional information on a graphic user interface provided for file search.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, For example, the GUI element as described in connection with FIG. 2, FIG. 3, FIG. 4, FIG. 5 and FIG. 6 can vary, so long as link information is provided thereto. Similarly, examples of an operating system (OS) for an electronic device such as a computer system used to support GUIs, include, but not limited to, Apple Mac OS, Microsoft Windows (Windows 95, Windows XP or Windows 2000), NEXTSTEP and the X Window system. Similarly, a central controller can be implemented as a chipset, or alternatively, a general or special purposed computer programmed to perform the methods as described with reference to FIG. 8. Accordingly, it is intended, therefore, that the present invention not be limited to the various example embodiments disclosed, but that the present invention includes all embodiments falling within the scope of the appended claims.

What is claimed is:

1. An apparatus for providing a user interface, the apparatus comprising:
a user interface unit arranged to provide a graphic user interface (GUI) by which a user searches for a file;
an additional information storage unit to store additional information in relation to a predetermined file, which is input through the graphic user interface (GUI) by the user; and
a control unit arranged to provide a visual display of the additional information on the graphic user interface (GUI).

2. The apparatus of claim 1, wherein the graphic user interface (GUI) comprises at least one filename of a file, and the additional information comprises at least one of a memo, a number, a leader line, a rim, and a font of the filename, and wherein the memo, the number, the leader line, and the rim are additionally displayed on the graphic user interface (GUI) at one side of the filename.

3. The apparatus of claim 1, further comprising:
a user input unit to enable the user to input user information; and
a link information storage unit to store link information between the additional information stored in the additional information storage unit and the predetermined file corresponding to the stored additional information.

4. The apparatus of claim 3, wherein the user input unit comprises at least one button, and a selection menu is displayed on the graphic user interface (GUI) when the user operates a predetermined button, and wherein the selection menu comprises menu items corresponding to additional information which can be input.

5. The apparatus of claim 2, wherein the control unit arranges filenames on the graphic user interface (GUI) based on the additional information.

6. A method of providing a user interface, the method comprising:
providing a graphic user interface (GUI) by which a user searches for a file;
storing additional information in relation to a predetermined file input, via the graphic user interface (GUI) by the user; and
displaying the additional information on the graphic user interface (GUI).

7. The method of claim 6, wherein the graphic user interface (GUI) comprises at least one filename of a file, and the additional information comprises at least one of a memo, a number, a leader line, a rim, and a font of the filename, and wherein the memo, the number, the leader line, and the rim are additionally displayed on the graphic user interface (GUI) at one side of the filename.

8. The method of claim 6, further comprising:
inputting user information, via the graphic user interface (GUI) by the user; and
storing link information between stored additional information and the predetermined file corresponding to the stored additional information.

9. The method of claim 8, wherein the inputting user information comprises displaying a selection menu on the graphic user interface (GUI), when the user operates a predetermined button in an input device comprising at least one button, and wherein the selection menu comprises menu items corresponding to additional information which can be input.

10. The method of claim 7, wherein the displaying the additional information comprises arranging filenames on the graphic user interface based on the additional information.

11. An electronic device comprising:
an operating system (OS) deployed to operate the electronic device; and
a graphic user interface (GUI) installed to enable a user to interact with the electronic device and search for a predetermined file in a directory,
wherein the GUI is configured to store additional information in relation to the predetermined file input, via the graphic user interface (GUI) by the user, and provide a visual display of the additional information on the graphic user interface (GUI).

12. The electronic device of claim 11, wherein the graphic user interface (GUI) comprises at least one filename of the predetermined file, and the additional information comprises at least one of a memo, a number, a leader line, a rim, and a font of the filename.

13. The electronic device of claim 12, wherein the memo, the number, the leader line, and the rim are additionally displayed on the graphic user interface (GUI) at one side of the filename.

14. The electronic device of claim 11, wherein the graphic user interface (GUI) is further configured to store link information between stored additional information and the predetermined file corresponding to the stored additional information.

15. The electronic device of claim 14, wherein the graphic user interface (GUI) is further configured to receive user information, via an input device, the user information displaying a selection menu on the graphic user interface (GUI), when the user operates a predetermined button in the input device comprising at least one button, and wherein the selection menu comprises menu items corresponding to additional information which can be input.

16. The electronic device of claim 11, wherein the graphic user interface (GUI) is further configured to arrange filenames based on the additional information.
